(19) United States
(12) Patent Application Publication
(10) Pub. No.: US 2008/0303820 A1
(43) Pub. Date: Dec. 11, 2008

(54) Common Phase Error vs. Time Display

(75) Inventor: Joseph Schachner, Suffern, NY (US)

Correspondence Address: LECROY CORPORATION, 700 CHESTNUT RIDGE ROAD, CHESTNUT RIDGE, NY, 10977, US

(73) Assignee: LeCroy Corporation

(21) Appl. No.: 12/127,928

(22) Filed: May 28, 2008

Related U.S. Application Data
(60) Provisional application No. 60/933,221, filed on Jun. 5, 2007.

(51) Int. Cl. G06T 11/20

(52) U.S. Cl. 345/440.1

(57) ABSTRACT

A method and apparatus for displaying information on a test and measurement apparatus are provided. The method comprises the steps of displaying a graph of an acquired signal, displaying a graph of Common Phase Error versus time data generated from the acquired signal, and aligning the graph of the acquired signal and the graph of the Common Phase Error in time.

### CROSS REFERENCE TO RELATED APPLICATIONS

This application claims the benefit of U.S. Provisional Application Ser. No. 60/933,221, filed Jun. 5, 2007, titled COMMON PHASE ERROR VS. TIME DISPLAY, currently pending, the contents thereof being incorporated herein by reference.

### BACKGROUND OF THE INVENTION

It has been understood for some time that Common Phase Error (CPE) can degrade orthogonal frequency division multiplexed (OFDM) signals. Many prior art articles discuss the phenomenon. One such article describing the effect includes “Common Phase Error Correction with Feedback for OFDM in Wireless Communication” by V. S. Abhayawardhana and I. J. Wassell, Common Phase Error Correction with Feedback for OFDM in Wireless Communication. IEEE Global Communications Conference (GLOBECOM 2002), November 2002.

### SUMMARY OF THE INVENTION

In the summer of 2006 the WiMedia PHY Certification and Interoperability group added a requirement to their Error Vector Magnitude (EVM) algorithm to detect CPE and low pass filter changes in CPE from symbol to symbol, so that rapid changes in CPE would degrade the EVM result, thus being properly represented in such testing. The group had found that if test equipment did not include the ability to detect such CPE, any test run could indicate an excellent EVM result for a signal that would have interoperability problems due to CPE. However, the Group did not indicate any manner by which such CPE measurement was to be revealed directly.

The inventors of the present invention have determined that when CPE is taken into account in accordance with the requirements of the noted standard, the effect of CPE on EVM is a numerical difference, thus reducing the measured EVM, and therefore giving a more realistic view of the actual response of a system after taking the real affect from CPE into account. The effect of CPE on a constellation is to smear the constellation by twisting it. However, the inventors of the present invention have determined that the combination of EVM and a smeared constellation provides no clue as to whether the CPE was large but relatively slow, or smaller but quickly varying; whether the CPE was random or varied in accordance with a pattern; and whether the CPE was constant throughout the transmission or was mostly in one part of the transmission.

Therefore, it would be beneficial to provide an improved test and reporting method and apparatus that overcame these limitations.

Still other objects and advantages of the invention will in part be obvious and will in part be apparent from the specification and the drawings.

The invention accordingly comprises the several steps and the relation of one or more of such steps with respect to each of the others, and the apparatus embodying features of construction, combination(s) of elements and arrangement of parts that are adapted to effect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 is a representation of a screen display of constellations generated in accordance with Error Vector Magnitude (EVM) algorithm to detect CPE when CPE filtering is in use in accordance with the invention;

FIG. 2 is a representation of a screen display of constellations generated in accordance with Error Vector Magnitude (EVM) algorithm to detect CPE when CPE filtering is not in use; and

FIG. 3 shows a CPE vs. Time trace and the acquired WiMedia signal that produced EVM values constellations of FIG. 1 in accordance with the invention.

### DESCRIPTION OF THE PREFERRED EMBODIMENTS

Therefore, in accordance with the invention the inventors have determined a method and apparatus by which additional CPE information is provided, allowing a user to gain additional crucial knowledge about CPE and its effect on various signals and measurements. The invention comprises a method and apparatus that produces CPE vs. Time data aligned to a transmitted signal. The invention further comprises a method and apparatus for producing a display of the CPE vs. Time data, and for exporting that data. The invention further allows for control of turning on or off the low pass filtering of CPE, thus allowing one to see and measure the effect that the low pass filtering of the CPE has on EVM.

A first preferred embodiment of the claimed invention corresponds to a WiMedia UWB analysis option which can be installed in LeCroy® Serial Data Analyzers.

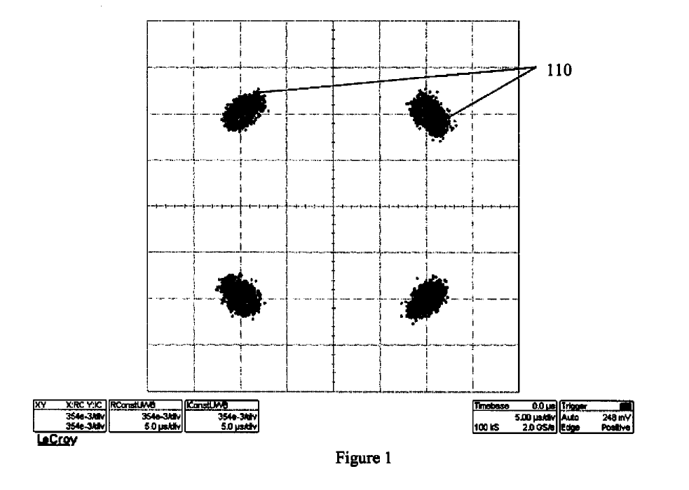

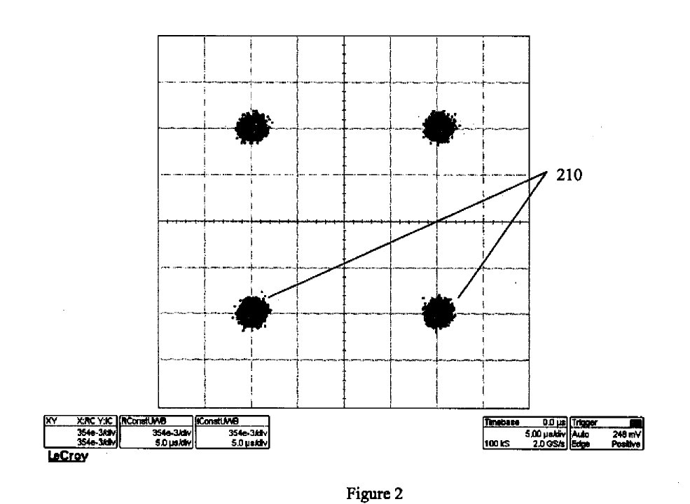

FIGS. 1 and 2 depict images from an analysis of a good WiMedia UWB signal. In each of these images, constellations are depicted showing the degree to which there may be unwanted phase and/or amplitude modulating in the system processing. Referring first to FIG. 1, the EVM when correctly low pass filtering CPE is −23.93 dB. However, as is shown in FIG. 2, if the low pass filtering of CPE is turned off, the EVM number improves to −25.89. When low pass filtering CPE, as shown in FIG. 1, a constellation 110 shows a slight elongation along a circular path, which is not present when low pass filtering of CPE is removed (see 210 in FIG. 2). This slight elongation represents imperfections in the CPE (based upon shifting of the phase modulation of the carrier signal) that are only accounted for when the filtering is turned on. When the filtering is not turned on, as in FIG. 2, no such elongation is shown, and therefore the signal appears better than it actually is. Thus, while the filtering allows for the proper consideration and display of problems with the signal based upon imperfections in the CPE that would not otherwise be visible, still further useful information is not provided by this display.

As noted, in accordance with the WiMedia standard measurement and correction required by the standard, it is not possible to know from these facts whether the CPE was fast but small or slow but large; whether it was random or not, etc.

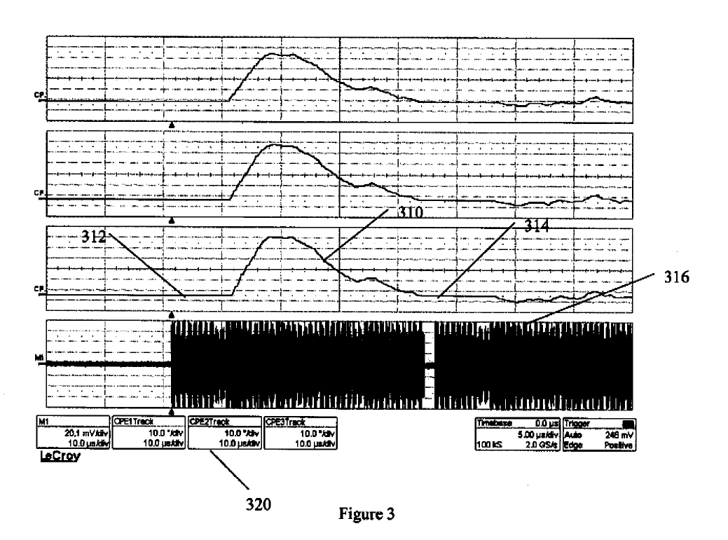

FIG. 3 shows a CPE (over three frequency bands) vs. Time trace aligned in time with the acquired WiMedia signal that produced EVM values given above and the constellation shown in FIG. 1, constructed in accordance with the present invention. As is shown in FIG. 3, a CPE vs. Time traces 310 is computed for each of a number of bands starting at Header symbols of each packet, through a PSDU (through the rest of the packet). The CPE vs. Time traces rest at 0 (see 312) before the first Header symbol of a packet and return to 0 at the end of each packet (see 314). (Any tilt in the CPE vs. Time trace would reflect frequency error, not CPE. Frequency error is compensated.) In FIG. 3, descriptor box 320 for the CPE vs. Time trace shows that vertical scaling is 10 degrees per division. Through the display of such a time-aligned trace 316 with the acquired signal, the additional information desired above is provided

By inspection of this display trace shown in FIG. 3, one can answer the questions posed above. It can now be determined in this particular example that the CPE was not fast but was fairly large; that the CPE was not random; and that there was one large excursion when the transmitter began transmitting after a long time not transmitting. This information provides an engineer a good clue about any processes that might be performed to reduce this unwanted effect.

Therefore, in accordance with the invention, rather than merely providing a CPE adjusted value for EVM, a CPE vs. time display is provided that is aligned in time with the acquired signal, thereby allowing the user to view additional attributes about the CPE information. Furthermore, by providing such EVM measurements when the CPE filtering of the invention is on or off, one is able to determine the effect such CPE has on the measured EVM.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed:

1. A method for displaying information on a test and measurement apparatus, comprising the steps of:
displaying a graph of an acquired signal;
displaying a graph of Common Phase Error versus time data generated from the acquired signal; and
aligning the graph of the acquired signal and the graph of the Common Phase Error in time.

2. The method of claim 1, wherein the graph of the acquired signal and the graph of the Common Phase Error are displayed on vertically separate grids employing a same horizontal time per division.

3. The method of claim 1, further comprising the step of selectively displaying a constellation diagram including low pass common phase error filtering and a constellation diagram excluding low pass common phase error filtering.

4. The method of claim 1, wherein the test and measurement apparatus is an oscilloscope.

5. A method for displaying information on a test and measurement apparatus, comprising the steps of:
selectively displaying a first constellation diagram utilizing a low pass filtering of the Common Phase Error and a second constellation diagram of the Common Phase Error without a low pass filtering thereof;
whereby an effect of this low pass filtering is discernable in accordance with the constellation diagrams.

6. The method of claim 5, further comprising the step of measuring error vector magnitude corresponding to each of the first and second constellation diagrams.

7. The method of claim 5, further comprising the steps of determining an effect of the low pass filtering in accordance with a comparison of the first and second constellation diagrams.

8. The method of claim 7, further comprising the step of determining whether the first or second constellations diagram is displayed.

9. A test and measurement apparatus for displaying information, comprising:
an acquisition system for acquiring a signal;
a processor for determining a Common Phase Error of the acquired signal versus time; and
a display for displaying a graph of the Common Phase Error of the acquired signal versus time in a time aligned manner with a graph of the acquired signal.

10. The test and measurement apparatus of claim 9, wherein the graph of the acquired signal and the graph of the Common Phase Error of the acquired signal are displayed on vertically separate grids employing a same horizontal time per division.

11. The test and measurement apparatus of claim 9, wherein the test and measurement apparatus is adapted to selectively display a constellation diagram including low pass common phase error filtering and a constellation diagram excluding low pass common phase error filtering.

12. The apparatus of claim 9, wherein the test and measurement apparatus is adapted to measure an error vector magnitude corresponding to each of the first and second constellation diagrams.

13. The test and measurement apparatus of claim 9, wherein the test and measurement apparatus is an oscilloscope.

14. A computer program for displaying information on a test and measurement apparatus, comprising instructions for performing the steps of:
displaying a graph of an acquired signal;
displaying a graph of Common Phase Error versus time data generated from the acquired signal; and
aligning the graph of the acquired signal and the graph of the Common Phase Error in time.

15. The computer program of claim 14, wherein the graph of the acquired signal and the graph of the Common Phase Error are displayed on vertically separate grids employing a same horizontal time per division.

16. The computer program of claim 14, further comprising instructions to perform the step of turning off low pass filtering of Common Phase Error.

17. The computer program of claim 14, wherein the test and measurement apparatus is an oscilloscope.

18. A computer program for displaying information on a test and measurement apparatus, comprising instructions for performing the steps of:
selectively displaying a first constellation diagram utilizing a low pass filtering of the Common Phase Error;
selectively displaying a second constellation diagram of the Common Phase Error without a low pass filtering thereof;
whereby an effect of this low pass filtering is discernable from a comparison of the first and second constellation diagrams.

19. The computer program of claim 18, further comprising the step of determining an Error Vector Magnitude corresponding to each of the first and second constellation diagrams.
